(19) United States
(12) Patent Application Publication
(10) Pub. No.: US 2004/0145805 A1
(43) Pub. Date: Jul. 29, 2004

(54) Unitary device with internal microscopic counting grid used for analysis of microscopic particles contained in liquid

(76) Inventor: Jean Qiu, Andover, MA (US)

Correspondence Address: Jean Qiu, 1 Copley Drive, Andover, MA, 01810, US

(21) Appl. No.: 10/760,000

(22) Filed: Jan. 16, 2004

Related U.S. Application Data
(60) Provisional application No. 60/440,364, filed on Jan. 16, 2003.

(51) Int. Cl. G02B 21/34; G01N 21/01

(52) U.S. Cl. 359/398; 359/396

(57) ABSTRACT

A unitary counting device for cells and other microscopic particles is described in this invention. The invention also relates to the method of producing the counting device and to the method of using the device. The counting device is constructed with a top part, a connection layer, a base part, and a grid of microscopic lines that are built inside a counting chamber to define counting areas. Furthermore, the counting chamber has a sample introduction port and an air escape port. A connection layer bonds the top part and the base along perimeter of the chamber and maintains gap uniformity. The connection layer consists of a polymer film sandwiched by two layers of pressure sensitive adhesive. Grid lines are fabricated using polymerizable solutions, for narrow and thin lines, which enable counting small particles under high magnifications.

### CROSS-REFERENCE TO RELATED APPLICATIONS

This application claims the benefit of U.S. provisional application 60/440,364, titled “Disposable cell counter”, filed on Jan. 16, 2003.

### BACKGROUND OF THE INVENTION

1. Field of the Invention

The present invention generally relates to devices for counting microscopic particles in solution. In particular, the microscopic particles may be cells or other biological objects.

2. Description of the Prior Art

Biological solutions, such as blood, spinal fluid, cell culture and urine, are routinely analyzed for their microscopic particle concentrations. As an example, for determining cell concentrations in biological solutions, a commonly used method is to spread the cell-containing solution into a thin layer without cell overlap in the vertical direction. A precise volume is determined by keeping the height of the solution at a known constant level. Cells are viewed under an optical microscope and enumerated in defined areas. To eliminate the variation caused by microscopes, an area-defining grid is preferred in the counting chamber. A commonly used cell counting device is called hemacytometer, as disclosed in U.S. Pat. No. 1,693,961 and U.S. Pat. No. 2,039,219.

The hemacytometer is a thick glass slide with three raised platforms. The central platform is lower than the two outer platforms by a given height, which is typically less than 1 mm. The central platform has precisely ruled grid lines etched into glass. A cover slip is placed on top of the raised platforms. The cover slip rests on the two outer and higher platforms, thus a gap is form between the cover slip and the central platform. When liquid is introduced into the gap between the cover slip and the central platform, the grid that is etched into the central platform defines sections for the particle-containing liquid. Using an optical microscope, particles are counted inside the counting grid. Concentration of particles can be obtained by calculation using the liquid volume within the grid and number of particles counted within the grid.

Before using a hemacytometer, the cell suspension is diluted so that the cells do not overlap each other on the grid, and that cells are uniformly distributed in the counting area. To load the counting chamber, the first step is to place the cover slip over the counting surface. Then the suspension is introduced into the area under the cover slip by capillary action through the side of the counting area. This can done with a pipette. Enough liquid must be introduced so that the central platform surface is just covered. (If too much liquid is introduced, liquid overflows the counting area. When this happens, the hemacytometer must be cleaned and dried with lens tissue, and reloaded.) The charged counting chamber is then placed on a microscope stage and the counting grid is brought into focus for counting.

Immediately after use, the cover slip is removed. Both the cover slip and the raised platforms are cleaned with water or with a mild cleaning solution, and then dried carefully.

In practice, it is desired to have a pre-assembled chamber that eliminates the error produced when the cover slip is misplaced or the chamber is over or under charged.

It is also desired to have a counting chamber with internal grid to eliminate the variation in area by different microscopes. It is further desired to have a counting chamber that is disposable after single use to eliminate the biohazard generated during washing hemacytometer.

Pre-assembled plastic slides with examination chambers formed between a base plate and cover plate is taught in U.S. Pat. No. 4,637,693. One side of the counting chamber is open to a liquid loading area. When liquid is placed in the loading area, capillary force draws the particle containing solution into the counting area. The disadvantage of connecting sample loading area with the counting area is the lack of support along the opening. During loading, the surface tension of the liquid may draw the top of the counting area towards the bottom, creating thickness variation, which contributes to counting inaccuracy.

In order to hold the top part and the bottom part of the chamber parallel, it is desired to have height defining walls surrounding the counting chamber entirely. Such devices without counting grid are disclosed in U.S. Pat. No. 4,441,793.

Pre-assembled plastic slides with examination chambers formed between a base plate and cover plate with raised lines 0.012 mm to 0.023 mm width and 0.008 mm height is taught in U.S. Pat. No. 4,997,266. To count small particles with sizes less than 1 to 10 micrometers, it is necessary to use high magnifications on the microscope, which requires much narrower lines to form the counting grid with much smaller areas. It is also necessary to obtain grid lines with less thickness than what is disclosed in U.S. Pat. No. 4,997,266, in order to reduce the influence of grid lines on uniform particle distribution during the sample loading process.

As evident from the discussion in this section, it would be desirable and advantageous to devise a cell and particle counting device that has a pre-assembled chamber with counting grids that are suitable for counting small particles and with improved loading accuracy than what is done with prior art. The pre-assembled device eliminates the error produced when the cover slip is misplaced or the chamber is over charged or under charged.

### SUMMARY OF THE INVENTION

The present invention provides a unitary, single-use counting chamber, for cells and other microscopic particles, with support walls around the entire chamber and with a high-resolution and fine-line counting grid.

In this invention, the novel disposable cell counting device is an enclosed counting chamber with two ports for sample application and air escape respectively. The two ports may be holes through the flat top of the counting chamber. The flat top part is held to a rigid and flat base part at a defined gap. Either the top part of the chamber or the base part of the chamber contains precisely spaced lines in a grid pattern. Both the top part and the base part are transparent, allowing cell counting in either transmission or reflection mode. The grid design is similar to the well-known Improved Neubauer pattern, as commonly used in hemacytometer. When the cell-containing solution is introduced into the counting chamber through one of the ports with a pipette, air escapes through the opposing port, leaving an evenly distributed liquid layer without air bubble. The particles are counted under an optical microscope. The particle concentration is calculated using the volume of liquid under the counting grid. The counting device is disposed after use.

The thickness of the liquid layer, which is confined within the counting area with the grid, is defined by the gap between the top and the base of the chamber. For counting accuracy, it is essential to maintain the liquid thickness constant. The present invention employs a supporting wall around the entire grid area.

The supporting wall around the counting area is formed by a connecting part, which surrounds the counting area. The purpose of the connecting part is to provide a constant gap between the top and the base parts of the chamber, as well as to bond the top part and the base part together to form an enclosed chamber.

The connecting part can be formed using pressure sensitive spacer adhesives. The spacer adhesive consists of a polymer film sandwiched by two layers of pressure sensitive adhesives. It serves purposes of bonding the top and the base parts of the counting chamber together as well as providing defined chamber height.

Most living cells give very little contrast in bright field microscopy because they have too little contrast to the solution surrounding them and they have no color. However the various organelles show wide variation in refractive index, which is the tendency of the materials to bend light. The phase contrast microscopy employs an optical mechanism to translate minute variations in phase into corresponding changes in amplitude, which can be visualized as differences in image contrast. With phase contrast microscopy, living cells and microorganisms are easily counted and characterized.

Plastic films that bear microscopic features are produced using polymerizable solutions. It was discovered by this inventor that the features in the film generate sufficient contrast under phase contrast microscope, even for features less than 3 micrometer wide and less than 0.5 micrometer thick. Using micro-replicated plastic film to produce counting grid allows (1) the cost of manufacturing to be low, and (2) the manufacturing of fine grid lines, which enables measurement of small particles less than 5 micrometer in diameter. The fine grid lines remove distortion of particle distribution during sample loading.

The present invention also describes the counting chamber with no phase distortion by the materials themselves. This property allows the phase contrast microscopy to be employed for particle evaluation.

The disposable nature of devices in the present invention allows the elimination of the cleaning procedure used with conventional hemacytometer. No cleaning simplifies the counting operation, as well as reduces the hazardous liquid waste, which may be biological or radioactive.

The procedure of particle counting in this invention consists of the following steps: (1) pipette cell-containing solution into counting chamber, (2) count cells, and (3) dispose used counting chamber.

The present invention is intended for counting cells and other microscopic particles in solution, such as spores, bacteria, and other microscopic organisms. Where appropriate, the term “cell” is used to represent cell and any other microscopic particle.

### BRIEF DESCRIPTION OF THE DRAWINGS

The invention will best be understood by reference to the accompanying drawings, wherein:

FIG. 1 contains schematic drawings of the disposable cell counting chamber, where FIG. 1(a) depicts the complete assembly, FIG. 1(b) shows the interior of the counting chamber by removing the top part, FIG. 1(c) represents top view and FIG. 1(d) represents side view;

FIG. 2 contains schematic drawings of the counting grid film, where FIG. 2(a) represents top view and FIG. 2(b) represents side view;

FIG. 3 shows illustrations of various possible surface features which form the grid lines, where FIG. 3(a) shows triangular recess, FIG. 3(b) shows triangular top, FIG. 3(c) shows recess with narrower bottom than its top, and FIG. 3(d) shows ridge top with narrower top than its bottom;

FIG. 4 shows schematics of the spacer adhesive, where FIG. 4(a) is top view, FIG. 4(b) is side view of the spacer adhesive with middle film, and FIG. 4(c) is side view of the spacer adhesive without middle film; and

FIG. 5 depicts a typical grid line pattern that is similar to the common improved Neubauer pattern.

These figures, which are idealized and are not to scale, are intended to be merely illustrative and non-limiting.

### DETAILED DESCRIPTION OF THE INVENTION

Counting Chambers

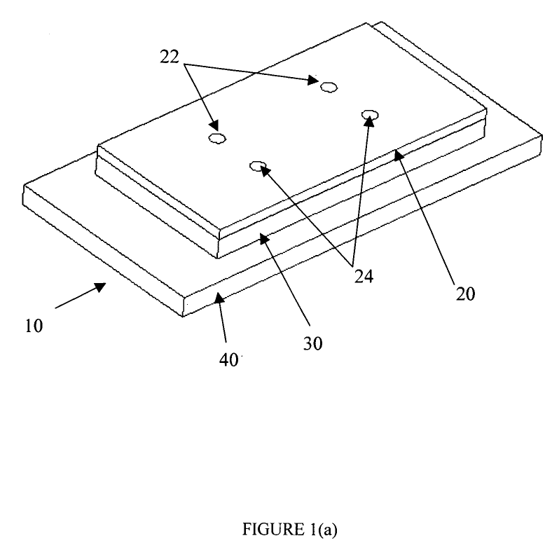

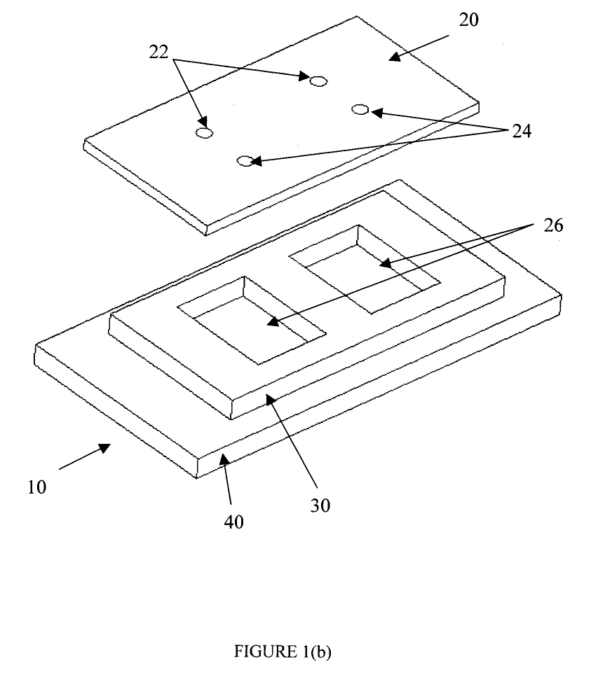

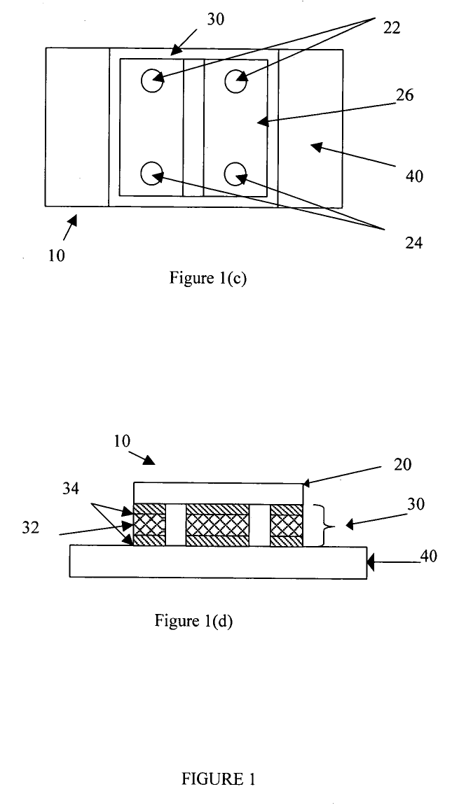

FIG. 1 shows a counting device according to the present invention. In this example, the counting device assembly has two identical counting chambers. In general, any number of chambers can be fabricated on a single assembly.

FIG. 1(a) depicts a complete counting device 10, with a top part 20, a connecting layer 30, and a base part 40. On the top part 20, there is a sample introduction port 22 and an air escape port 24 for each counting chamber. FIG. 1(b) shows the interior of the two counting chambers 26, and FIG. 1(c) is a top view. Typically, the sample introduction port 22 and the air escape port 24 are round holes in top part, and the diameter of the holes may be in the range of 1 mm to 4 mm. The dimension of the chambers 26 may be 10 mm by 18 mm. The base part may be 25 mm by 75 mm, with a thickness of 1 mm.

For each counting chamber, the area under which optical observation must take place for counting cells are typically halfway between the sample introduction port 22 and the air escape port 24.

Top Part

The top part 20 is made of a film or sheet of plastic, glass, or another rigid material. There are two ports 22 and 24 for each counting chamber through the top part. The cell containing solution is inoculated through one of the ports 22 while the opposite port 24 allows the air to evacuate. The ports may be round through holes in the top part, with a diameter of 2.4 mm. Suitable diameters may be in the range of 1 mm to 4 mm. The thickness of the top part 20 can be within the range of 0.01 mm to 3 mm, and is preferably within 0.25 mm to 1 mm.

Connecting Layer

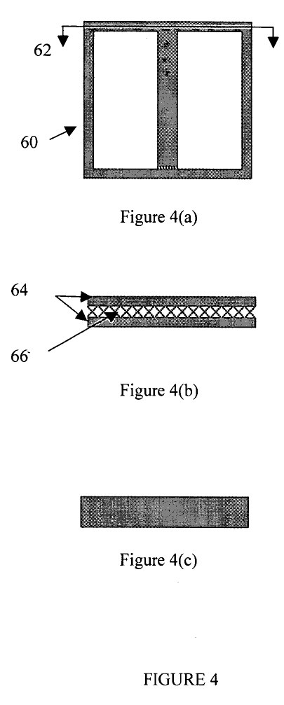

The connecting layer 30 may be made of a spacer film. As shown in FIG. 1(d), the spacer film 30 consists three layers. The middle layer 32 is a polymer film. Two layers 34 of pressure sensitive adhesive (PSA) are coated on both the top and the bottom side of the polymer film. The adhesive layers are protected by polymer-coated paper-liner sheets, not shown here, one on either side of the spacer film 30. The whole film stack is suitable for die cutting. For the current invention, the spacer adhesive is cut into shape, shown as 30 in FIG. 1(b) and as 60 in FIG. 4(a), using a steel rule die.

During cell counting chamber assembling, the top PSA 34 adheres to the top part 20, while the bottom PSA 34 adheres to the base part 40, and an enclosed chamber 26 is formed. The total thickness of the PSA and polymer layers determines the chamber height.

The total thickness of the spacer is chosen to be suitable for cell counting. Different sized cells require different thickness. It can range from 0.01 mm to 5 mm, preferably between 0.02 mm to 1 mm.

It is also possible to use only adhesives to define the chamber height. This kind of adhesive comes with both protective liners. The first liner is removed to allow one side of the adhesive to adhere to the top part. The second liner is then removed to join the top part to the base part.

Any kind of adhesive that can provide adequate adhesion between the top and the base parts can be used. A preferable adhesive system is the pressure sensitive adhesive, which comes as a sheet format that can be cut into desired shapes.

FIG. 4 shows schematics of the spacer adhesive, where FIG. 4(a) is top view, FIG. 4(b) is side view of the spacer adhesive with middle film, and FIG. 4(c) is side view of the spacer adhesive without middle film.

One alternative to the spacer pressure sensitive adhesive is to use adhesives dispersed with spacer beads. They are commonly used in making liquid crystal displays by the display industry. In this approach, beads with diameters equal to chamber gap are dispersed into an adhesive pre-cursor solution. The mixture is then applied onto defined locations on either the top part or the base part to form the outlines of the counting chamber. The top part and the base part are brought together and held in place when an energy source (heat or radiation, such as ultraviolet light or e-beam) solidifies the adhesive. The solidified adhesive bonds the two parts together. The thickness of the adhesive, determined by the spacer beads, defines the gap for the counting chamber.

Base Part

The base part 40 provides mechanical strength for the counter as well as optical clarity for counting operation. The counter has to be flat and rigid so that (1) the counting grid is in focus under the field of view of an optical microscope, and (2) the layer of cell-containing liquid is kept at a defined thickness. The base 40 should not introduce any visual defect that interferes with cell counting, both from its surface and inside its bulk. The base part 40 must be optically clear so that light can pass through the base to the cell-containing liquid inside the counting chamber 26.

Almost any material can be used for the base, as long as that material is substantially optically clear, having good strength and thermal stability. A microscope slide or any transparent plastic sheet or glass can be used as the base. Examples of suitable plastic materials include triacetate film, vinyl film, and vinyl-PET laminates.

Counting Grid

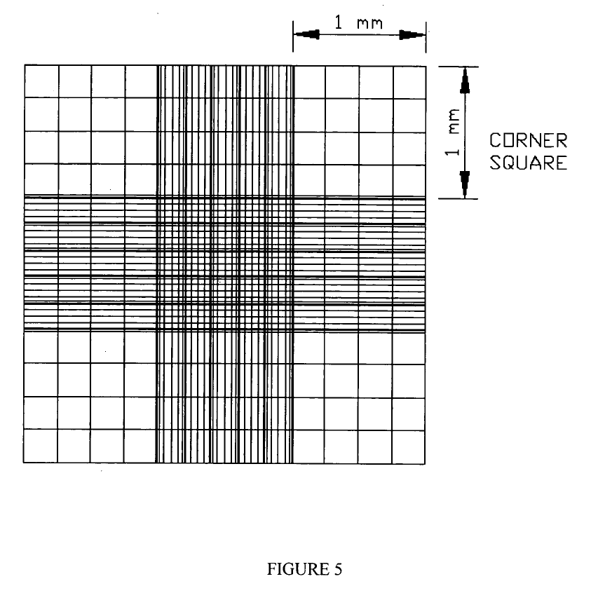

The counting grid defines areas for cell counting. FIG. 5 shows one design of the counting grid that is suitable for cell counting. The grid can be incorporated into either the top part 20 or the base part 40 of the counting chamber. Furthermore, for focusing the gridlines and cells simultaneously within the depth of field of the microscope, the counting grid is preferably incorporated into the inside of the counting chamber. If the counting grid is incorporated into the top part 20, the counting grid is preferably incorporated into the bottom side of the top part 20. Conversely, if the counting grid is incorporated into the base part 40, the counting grid is preferably incorporated into the top side of the base part 40.

For ease of manufacture, preferably the counting grid is incorporated into a grid film. The grid film is a transparent film with a grid pattern that defines the counting area. The most economical material for the grid film is a plastic film. The grid pattern may be formed by applying a coating of the uncured flowable polymerizable solution to one surface of a base film, and then contacting the uncured flowable polymerizable coating with a configured molding surface having a series of cavities of the desired pattern. Pressure is applied to cause the flowable uncured polymerizable solution to fill the cavities of the molding surface, and the solution is maintained in contact with the molding surface while the coating is exposed to a curing agent to cause it to cure and harden. The curing agent may be ultraviolet light, electron beam, or heat. Once the coating has been sufficiently cured, it is separated from the molding surface. The patterned polymer layer is adherently and permanently bonded to the base film and the composite sheet material forms the grid film.

Creation of microscopic features in plastic material from a molding surface has been described in the prior art. Process of making optical disks with microscopic features using photo-polymerizable materials is disclosed in U.S. Pat. No. 4,374,077. Microstructure-bearing composite plastic articles and method of making said articles are disclosed in U.S. Pat. No. 5,175,030. Grid lines directly molded onto the plastic for cell counting is disclosed in U.S. Pat. No. 4,997,266. With the molding method, the grid lines can only be built into a rigid part, governed by the injection molding process. Another method called hot stamping or embossing has been used to create holographic films. In the embossing process, a plastic film is pressed against a heated negative molding surface. The plastic in contact with the tool is hot enough to flow, filling the cavities on the surface of the tool. Upon cooling, the plastic film is removed from the tool, bearing features that are negative topography of the mold. A variation of the embossing method is to melt the plastic and cast it onto a tool with a negative molding surface.

The tool that provides the negative molding surface can be made from polymeric, metallic, composite, or ceramic materials. In some instances, the polymerizable material may be cured by radiation being applied through the tool. In such instances, the tool should be sufficiently transparent to permit irradiation of the polymerizable material. For features that are in the range of smaller than 50 micrometer, photolithographic methods can be used to define the features. With this method, a uniform layer of photo-sensitive material is coated onto a surface. Certain areas of the photo-sensitive material is exposed to light and later removed from the surface. In some cases, the patterned photo-sensitive material is adequate as a tool. In other cases, a chemical etching process is applied to remove part of the underlying etchable surface that is not protected by the photo-sensitive material. After etching, the whole area is stripped of the photo-sensitive material, exposing the surface pattern formed on the underlying etchable material.

Illustrative examples of the photo-sensitive material are photoresists commonly used in semiconductor processing. The etchable material can be a metal, such as Al, Cu, Cr, or other materials used for fabricating photomask, such as ion oxide, aluminum oxide. The etchable material can also be inorganic sheets or films, such as SiO₂, Si₃N₄, TiO₂. The etchable material can also be glass.

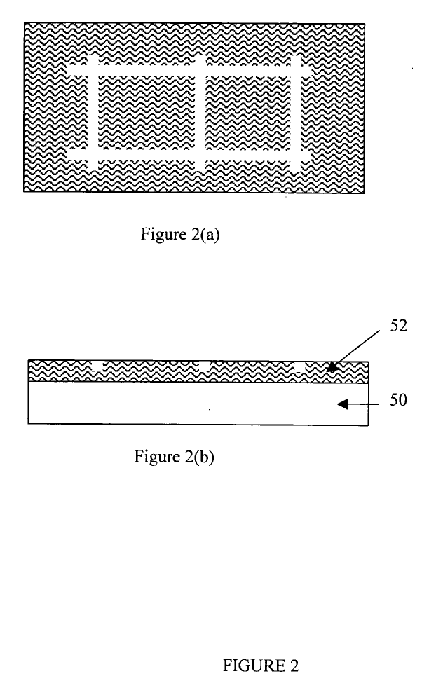

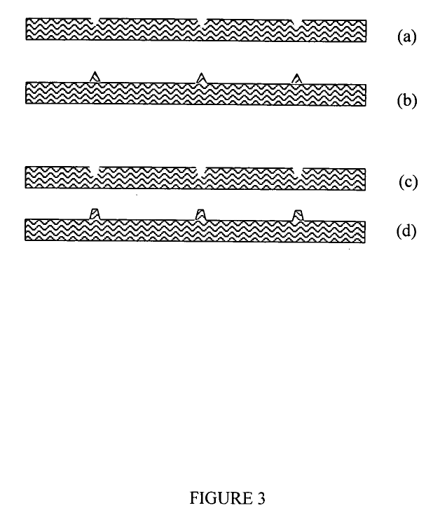

FIG. 2 contains schematic drawings of the counting grid film, where FIG. 2(a) represents top view and FIG. 2(b) represents side view. FIG. 3 shows illustrations of various possible surface features which form the grid lines, where FIG. 3(a) shows triangular recess, FIG. 3(b) shows triangular top, FIG. 3(c) shows recess with narrower bottom than its top, and FIG. 3(d) shows ridge top with narrower top than its bottom.

Example of Making Cell Counting Devices

A. Counting Grid Film

The counting grid film consists of two layers. The base substrate is a 10-mil (namely, 0.010 inch thick) polycarbonate film. It was purchased from Tekra Co. The second layer is a clear plastic with grid lines formed on its surface.

The process of fabricate the grid film consists of the following steps:

(1) Make a master tool that has a negative image of the grid line pattern.

(2) Prepare a UV polymerizable solution.

(3) Cast the UV polymerizable solution between the base substrate and the master tool.

(4) Expose the assembly made in step (3) with UV light, resulting in a film that has a grid pattern, as depicted in FIG. 5.

(5) Remove the grid film from the master tool.

Steps (3) to (5) can be repeated to produce multiple grid films.

B. Top Film

The counting grid film is cut to size and placed within a hole-punching die set. Two holes of 2.4 mm in diameter are cut through the grid film.

C. Spacer Adhesive

The spacer adhesive is cut to dimension of 10 mm by 18 mm using a steel rule die. The cutout area is then removed.

D. Microscope Slide is Used as the Base

E. Assemble the Cell Counter

The top film is laminated to one side of the spacer adhesive after removing one protective liner from the adhesive. The combined part is then laminated to glass slide after removing the protective liner from the other side of the spacer adhesive.

TABLE 1
Summary of components and raw materials

| Name | Material | Product Information | Vendor |
|---|---|---|---|
| Spacer | 3M Membrane | 7945MP | 3M Company |
| adhesive | Switch Spacer | | St Paul, |
| | | | Minnesota |
| Base substrate | Bayer | DE 1-1D Makrofo | Tekra Co. |
| | Polycarbonate | polycarbonate film | New Berlin, |
| | film | Gloss/Gloss with liners | WI |
| UV | Lens bond | SK-9 | Summers |
| polymerizable | | | Optical |
| solution | | | Hatfield, PA |
| Microscope | Glass | (Commodity) | (Commodity) |
| slide | | | |

Example of Counting Cells

The concentration of Human T Lymphocyte cells were measured using both the cell counter described in the present invention (Model CG2 Cellometer™ from Nexcelom Bioscience LLC, Lawrence, Mass.) and a common hemacytometer. The Model CG2 disposable cell counter consists of a counting grid with sample introduction and air escape ports, and a glass base.

Both CG2 disposable cell counter and the Hemacytometer have counting grids depicted in FIG. 5. The liquid volume under each corner square is 10⁻⁴ ml. The total number of cells in all four corner squares are counted. The cell concentration is calculated by the average number of cells in the corner square divided by 10⁻⁴ ml.

The hemacytomer is cleaned after each use with alcohol. Multiple CG2 counting chambers were used for counting and were disposed after single use. The steps of this experiment are listed as follows.

Step 1: Mix cell containing solution.

Step 2: Load cell counting chambers.

Step 3: Count the total number of cells inside the counting grid.

Step 4: Dispose used CG2 cell counter or wash used hemacytometer.

Step 5: Obtain cell concentration by dividing the total number of cell counted by the volume of liquid.

Results:

| | Cellometer CG2 | Hemacytomer |
|---|---|---|
| Number of tests | 17 | 17 |
| Mean cell concentration | 1.87 × 10⁵ | 1.82 × 10⁵ |
| (cells/ml) | | |

In conclusion, the cell counting results using CG2, which is made according to the present invention, and hemacytomer were equivalent. With CG2, sample loading was simple and consistent. There was no washing and drying involved in using CG2, which eliminated the potential biohazard.

Various modifications and alterations of this invention will become apparent to those skilled in the art without departing from the scope and spirit of this invention.

What is claimed is:

1. A unitary chamber for counting microscopic objects in liquid, comprising
a top part,
a base part,
a counting grid,
a connecting layer,
a sample introduction port,
and an air escape port,
wherein said connecting layer is between said top part and said base part, and wherein said connecting layer is at a pre-determined thickness.

2. The unitary chamber as defined in claim 1, wherein said counting grid is an integral part of said top part.

3. The unitary chamber as defined in claim 2, wherein said counting grid is on the bottom side of the said top part.

4. The unitary chamber as defined in claim 1, wherein said counting grid is an integral part of said base part.

5. The unitary chamber as defined in claim 4, wherein said counting grid is on the top side of the said bottom part.

6. The unitary chamber as defined in claim 1, wherein said sample introduction port and said air escape port are integral parts of said top part.

7. The unitary chamber as defined in claim 1, wherein said counting grid line width range from 0.1 micrometer to 1 mm.

8. The unitary chamber as defined in claim 1, wherein said counting grid line width range from 1 micrometer to 25 micrometer.

9. The unitary chamber as defined in claim 1, wherein said counting grid line thickness ranges from 0.1 micrometer to 50 micrometer.

10. The unitary chamber as defined in claim 1, wherein said counting grid is made by polymerizable solution.

11. The unitary chamber as defined in claim 1, wherein said counting grid is made by the radiation polymerizable solution.

12. The unitary chamber as defined in claim 1, wherein said counting grid is made by the ultraviolet light polymerizable solution.

13. The unitary chamber as defined in claim 1, wherein said counting grid is made by polymerizable solution onto the bottom side of the top part.

14. The unitary chamber as defined in claim 1, wherein said counting grid is made by polymerizable solution onto the top side of the base part.

15. The unitary chamber as defined in claim 1, wherein said connecting layer is made with adhesives dispersed with gap defining particles.

16. The unitary chamber as defined in claim 1, wherein said connecting layer consists of only pressure sensitive adhesives.

17. The unitary chamber as defined in claim 1, wherein said connecting layer consists of a plastic film, sandwiched by two layers of pressure sensitive adhesives.

18. A unitary device with plurality of unitary chambers as defined in claim 1.

19. A method of making a unitary chamber for counting microscopic objects in liquid, said chamber comprising
a top part,
a base part,
a counting grid,
a connecting layer,
a sample introduction port,
and an air escape port,
wherein said connecting layer is between said top part and said base part, and wherein said connecting layer is at a pre-determined thickness.

20. A method of counting microscopic objects in liquid with a unitary chamber, said chamber comprising
a top part,
a base part,
a counting grid,
a connecting layer,
a sample introduction port,
and an air escape port,
wherein said connecting layer is between said top part and said base part, and wherein said connecting layer is at a pre-determined thickness.
